(19) United States
(12) Patent Application Publication
(10) Pub. No.: US 2026/0107031 A1
(43) Pub. Date: Apr. 16, 2026

(54) Frame-Based Tracking System and Method For Pricing Media Content Consumption

(71) Applicant: AdCoach Inc., New Rochelle, NY (US)

(72) Inventor: Benjamin George Silverstein, New Rochelle, NY (US)

(21) Appl. No.: 18/914,287

(22) Filed: Oct. 14, 2024

(51) Int. Cl. H04N 21/2543; H04L 67/306

(52) U.S. Cl. CPC H04N 21/2543; H04L 67/306

(57) ABSTRACT

A frame-based tracking system is disclosed that comprises a computing device having a processor and a memory, which stores one or more instructions executable by the processor. The computing device comprises a time-based credit module, a tracking module, a time estimation module, a payment gateway module, and a notification module. The proposed frame-based tracking system provides precise, frame-based tracking of media consumption, thereby allowing a user to only be charged for media content through purchased time credits. The frame-based tracking system monitors the number of frames of the media content viewed by the user, and then accurately estimates and deducts the corresponding amount of time from the time credits. The frame-based tracking system provides a cost-effective pricing model compared to traditional flat-rate or subscription-based systems.

### FIELD OF INVENTION

The present disclosure relates generally to video technology, and more particularly to a frame-based tracking system that tracks media content consumption at a frame level and applies a pricing model for purchasing time credits, which are automatically deducted based on the frames of the media content consumed by a user, thereby offering a precise and flexible approach to content access and payment.

### BACKGROUND

A rapid growth of e-learning platforms has led to various pricing models for users to access educational content, with most platforms offering either subscription-based services or charging on a per-course basis. While these models aim to provide flexible learning, the models also present financial and usage inefficiencies for users. High subscription costs for platforms that users may only intermittently use, or payments for individual courses that may not be fully consumed, often result in dissatisfaction.

Most e-learning platforms today rely on traditional pricing models that can be divided into two main types: per-course pricing, and monthly or yearly subscription plans. These models, while common, often do not cater to the diverse needs of learners, resulting in inefficiencies and high costs for many users.

In a per-course pricing model, users are required to pay a set fee for each course to access the course. This model assumes that learners will complete the entire course and benefit from the full range of content provided. However, research and user data have consistently shown that many learners do not finish the purchased courses. This underutilization leads to significant financial inefficiencies, as learners pay for content that is never actually use. Furthermore, the per-course model often discourages exploration—if a user wants to access just a few lessons or modules from different courses, the user would still be required to purchase the full course for each, leading to unnecessary expenses.

On the other hand, monthly or yearly subscription plans offer users unlimited access to all content on a platform for a fixed fee. While this may appear more flexible at first glance, it poses problems for selective learners or those with limited time. Learners who only intend to take a few courses or explore certain lessons often end up paying the same subscription fees as those who consume vast amounts of content. This makes the service disproportionately expensive for casual or selective learners. For example, a user who only watches a few hours of content each month pays the same subscription fee as someone who consumes hours of content daily, leading to a perception of poor value for money.

Moreover, these subscription plans often require users to commit to long-term payment structures, such as yearly plans, which can range in the hundreds of dollars. While this may seem economical for heavy users, it becomes an obstacle for more casual learners who do not need constant access. These long-term commitments can also discourage users from exploring multiple platforms. Since the users have already invested in a yearly subscription for one platform, the users are less likely to pay for another, even if it offers content that may better suit their needs. This limits the user's ability to diversify their learning across platforms, locking them into a single ecosystem simply because of the financial commitment.

Several existing technologies and pricing models attempt to overcome these issues. Some platforms offer free content with an option to upgrade to premium content, but premium plans often still require long-term subscriptions or per-course fees. Some platforms charge users for individual courses, but the cost may still be prohibitive, especially if the user only wants a small portion of the content. Some platforms provide users with unlimited access but is often expensive for casual learners who don't consume large amounts of content.

While existing pricing models offer varying degrees of flexibility, they fail to solve the core issue of cost-efficiency and flexible usage. Freemium models often leave users dissatisfied when the users need premium content but find the premium plans expensive or overly restrictive. Pay-per-course models can be expensive for users who may only want to access a portion of a course but are forced to pay for the entire offering. Subscription models are highly prohibitive, especially yearly plans, which can range in the hundreds of dollars, forcing users to remain on a single platform to justify their expenditure.

These shortcomings create a barrier for users who wish to explore multiple learning platforms or selectively consume content based on their needs. To address these limitations, there is a need for an e-learning platform that developers a unique time-based credit module pricing and tracking system. There is a need for a system that provide a more flexible and cost-effective solution for users.

### SUMMARY OF THE INVENTION

The following presents a simplified summary of one or more embodiments of the present disclosure to provide a basic understanding of such embodiments. This summary is not an extensive overview of all contemplated embodiments and is intended to neither identify key nor critical elements of all embodiments, nor delineate the scope of any or all embodiments.

The present disclosure, in one or more embodiments, relates a frame-based tracking system that tracks media content consumption at a frame level and applies a pricing model for purchasing time credits, which are automatically deducted based on the frames of the media content consumed by a user, thereby offering a precise and flexible approach to content access and payment.

An embodiment of a first aspect, a frame-based tracking system comprises a computing device having a processor and a memory, which stores one or more instructions executable by the processor. These instructions may be executed to cause the frame-based tracking system to perform the various functionalities. The computing device comprises a user profile module, a time-based credit module, a tracking module, a time estimation module, a payment gateway module, and a notification module.

An embodiment of the first aspect, the computing device is in communication with a server and a database via a network.

An embodiment of the first aspect, the user is allowed to create a user profile through the user profile module through the computing device. The user profile module is configured to access the time-based credit module for the user to store time credits for a subscription period. The payment gateway module is configured to allow the user to purchase the time credits through a various payment method. The time credits are measured in either minutes or hours. The subscription period includes a time period ranging from 15 min to per month.

An embodiment of the first aspect, the user is allowed to select and purchase a desired amount of time credits by selecting a pricing option from various pricing options, thereby selecting the subscription period. The subscription period include, but are not limited to, a free subscription period with 15 minutes of content, a subscription period with 60 minutes of monthly content for any course or video, a subscription period with two hours of monthly content for any course or video, a subscription period with five hours of monthly content for any course or video, a subscription period with 10 hours of monthly content for any course or video, or an unlimited subscription period.

An embodiment of the first aspect, the user is allowed to select a video from a database through the user interface. The video comprises the plurality of frames. The tracking module is configured to track a number of frames viewed by the user from a plurality of frames of a selected video. The tracking module is further configured to determine a frame rate of the video, and calculate the total number of frames viewed based on the frame rate and the duration of playback of the selected video. This is achieved by determining the frame rate (measured in frames per second, or FPS) and correlating it with the duration of the selected video played.

An embodiment of the first aspect, the time estimation module is configured to estimate and deduct an amount of time from the purchased time credits based on the number of frames viewed by the user in the selected video. The processor is further configured to display a remaining amount of time in the time-based credit module through the user profile. Furthermore, the payment gateway module is configured to renew the time credits in the time-based credit module when the purchased time credits are depleted by allowing the user to either purchase additional amounts of time or the time-based credit module is automatically renewed after the completion of the subscription period. The payment gateway module is configured to allow the user to upgrade, downgrade, or cancel the subscription period, and automatically renew the time credits at the end of each subscription period. The payment gateway module is configured to provide various payment methods for the user to purchase the time credits.

An embodiment of the first aspect, the notification module is configured to alert the user as a time credits status when the time credits in the time-based credit module is nearing depletion.

An embodiment of a second aspect, a method for frame-based tracking and pricing the video consumption is provided. First, the user could create the user profile by providing user data through the user profile module. The user data includes, but is not limited to, name, age, and preferred types of videos, etc. Next, the frame-based tracking system creates the user profile module in the frame-based tracking system with the time-based credit module after completion of the user data input.

In one embodiment, the user selects and purchases the desired amount of time credits by selecting a pricing option from various pricing options, through the payment gateway module.

Next, after purchasing the desired amount of time credits, the user is allowed to select at least one video from the database. Next, the tracking module tracks the number of frames viewed by the user from the plurality of frames of the selected video. Next, the time estimation module estimates and deducts an amount of time from the purchased time credits based on the number of frames viewed by the user in the selected video. Next, the remaining amount of time in the time-based credit module is displayed through the user profile module.

Later, if the purchased time credits are exhausted, the user is redirected to the payment gateway module.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

The accompanying drawings, which are incorporated in and constitute a part of the specification, illustrate an embodiment of the invention, and, together with the description, explain the principles of the invention.

FIG. 1 illustrates a block diagram of a frame-based tracking system for video consumption, in accordance with embodiments of the invention.

FIG. 2 illustrates a flow chart of a method for tracking and pricing for video consumption, in accordance with embodiments of the invention.

### DETAILED DESCRIPTION

Reference will now be made in detail to the present preferred embodiments of the invention, examples of which are illustrated in the accompanying drawings. Wherever possible, the same reference numerals are used in the drawings and the description to refer to the same or like parts.

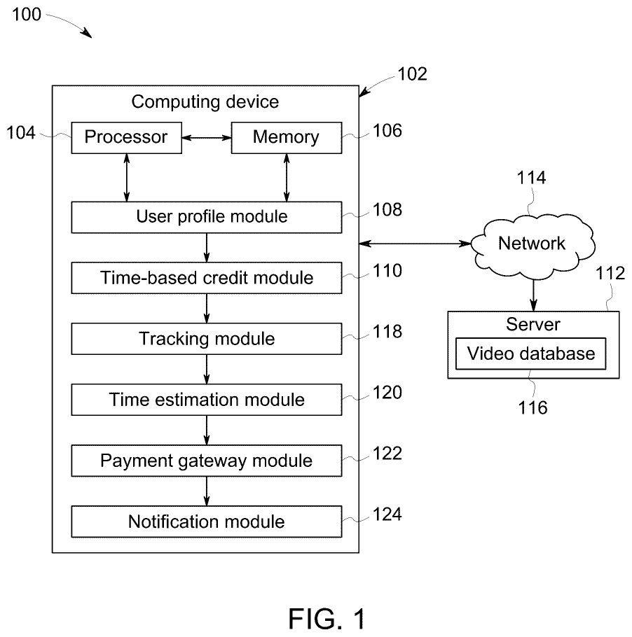

FIG. 1 refers to a block diagram of a frame-based tracking system 100 for video consumption. The frame-based tracking system 100 provides a unique approach to media content consumption through frame-based tracking and time credit deduction. The frame-based tracking system 100 comprises a computing device 102 having a processor 104 and a memory 106, which stores one or more instructions executable by the processor 104. These instructions may be executed to cause the frame-based tracking system 100 to perform the various functionalities. The computing device 102 comprises a user profile module 108, a time-based credit module 110, a tracking module 118, a time estimation module 120, a payment gateway module 122, and a notification module 124.

In an embodiment, the processor 104 acts as the central processing unit (CPU) of the frame-based tracking system 100, responsible for coordinating different tasks and carrying out complex operations, data processing, and decision-making by fetching instructions from the memory 106, thereby decoding the instructions and executing the necessary actions.

In one embodiment, the memory 106 serves as the storage component for storing various types of information and executable instructions that are vital for the frame-based tracking system 100 and the processor 104. The frame-based tracking system 100 ensures that the processor 104 can quickly access and execute the instructions to maintain efficient operation.

In one embodiment, the computing device 102 could be an electronic device that a user can utilize to interact with the frame-based tracking system 100. The computing device 102 could be, but not limited to, a smartphone, a laptop, a tablet, a personal computer, and other suitable electronic devices. The computing device 102 serves as the user's gateway to access and interact with the frame-based tracking system 100. The computing device 102 is configured to enable the user to engage with the system's functionalities and capabilities through a user interface.

In one embodiment herein, the user interface is a crucial component of the computing device 102, which allows the user to input commands, receive information, and control the frame-based tracking system 100. The user interface could be, but not limited to, a touch screen, a keyboard, a mouse, voice recognition modules, gesture recognition sensors, and virtual reality interfaces.

In one embodiment herein, the computing device 102 is in communication with a server 112 and a database 116 via a network 114. The network 114 acts as a communication that allows the computing device 102 to interact with the other components of the frame-based tracking system 100, thereby facilitating the exchange of data, commands, and information. In one embodiment herein, the network 114 could be a wireless communication infrastructure, which offers the user flexibility and convenience when interacting with the frame-based tracking system 100. This wireless connectivity enables the user to access the frame-based tracking system 100 from various locations without being tethered to a fixed physical connection.

In one embodiment herein, the network 114 could be, but not limited to, Local Area Network (LAN), Cellular Network, Wide Area Network (WAN), Intranet, Virtual Private Network (VPN), and wireless networks that use radio frequency (RF) or infrared (IR) technology to transmit data without the need for physical cables, thereby providing mobility and flexibility. The versatility of the network 114 ensures that the computing device 102 can seamlessly connect to the server 112 and the database 116, thereby enabling the user to access the system's functionalities and resources from a variety of locations and devices. This wireless connectivity enhances the overall accessibility and convenience of the frame-based tracking system 100 for the user.

In one embodiment, the user is allowed to create a user profile through the user profile module 108 using the computing device 102. The user profile module 108 is configured to access the time-based credit module 110 for the user to store time credits for a subscription period. The payment gateway module 122 is configured to allow the user to purchase the time credits through various payment methods. The time credits are measured in at least one of minutes and hours. The subscription period include, but is not limited to, a free subscription period with 15 minutes of content, a subscription period with 60 minutes of monthly content for any course or video, a subscription period with two hours of monthly content for any course or video, a subscription period with five hours of monthly content for any course or video, a subscription period with 10 hours of monthly content for any course or video, or an unlimited subscription period offering unrestricted viewing for any course or video, available at an affordable annual fee.

The frame-based tracking system 100 allows the user to select and purchase a desired amount of time credits by choosing from at least one pricing option from various pricing options, thereby selecting the subscription period.

In one embodiment herein, the user is allowed to select one or more video or media contents from the database 116 through the user interface. The video comprises the plurality of frames. In one embodiment herein, the tracking module 118 is configured to track a number of frames viewed by the user from a plurality of frames of a selected video or media content. The tracking module 118 is further configured to determine a frame rate of the video, and estimate the total number of frames consumed based on the frame rate and the duration of playback of the selected video. This is achieved by determining the frame rate (measured in frames per second, or FPS) and correlating it with the duration of the selected video played. For example, if the selected video plays at a frame rate of 60 FPS, the tracking module 118 tracks that every 60 frames viewed equates to one second of playback time. This one second is then deducted from the purchased time credits in the time-based credit module 110 by the time estimation module 120. The tracking module 118 ensures precise time tracking by accounting for the actual video consumed, thereby allowing for accurate deductions based on real-time video engagement, regardless of playback speed or interruptions.

In one embodiment herein, the time estimation module 120 is configured to estimate and deduct an amount of time from the purchased time credits based on the number of frames viewed by the user in the selected video. The processor 104 is further configured to display a remaining amount of time in the time-based credit module 110 through the user profile module 108. Once the purchased time credits are exhausted, the user is restricted from accessing additional video until the user either purchase more time credits from the pricing options or wait for the next month when the subscription period automatically renews. This ensures that the user can easily track the time credits and make informed decisions about purchasing additional content based on the user's needs.

In one embodiment herein, the payment gateway module 122 is configured to renew the time credits in the time-based credit module 110 when the purchased time credits are depleted by allowing the user to either purchase additional amounts of time or the time-based credit module 110 is automatically renewed after the completion of the subscription period. The payment gateway module 122 is configured to allow the user to upgrade, downgrade, or cancel the subscription period, and automatically renew the time credits at the end of each subscription period. The payment gateway module 122 is configured to provide various payment methods for the user to purchase the time credits.

In one embodiment herein, the payment gateway module 122 is designed to offer the user the flexibility to upgrade, downgrade, or cancel the subscription period, while also facilitating the automatic renewal of time credits at the end of each subscription period. Additionally, the module supports various payment methods, providing the user with multiple options to purchase their desired time credits.

In one embodiment, the user is allowed to subscribe to a new subscription period, cancel the current subscription period, or select a different subscription period at any time. When the new subscription period is purchased, any remaining time from the previous subscription period will be forfeited and replaced with the time allocated in the new subscription period. This feature ensures a smooth transition between subscription levels.

For example, if the user subscribes to a pricing option from the various pricing options on January 1^{st} and does not manually select a new pricing option before a renewal date, the current active pricing option will automatically renew on February 1^{st}. If the user decides to purchase a different pricing option at any time between January 1^{st} and February 1^{st}, a new subscription pricing option will be created, replacing the previous subscription, and the auto-renewal will be adjusted based on the date of the new pricing option's purchase. This functionality allows the user to maintain uninterrupted access to video while accommodating their viewing preferences and needs.

In one embodiment herein, the frame-based tracking system 100 also includes a notification module 124, which is configured to alert the user as a time credits status when the time credits in the time-based credit module 110 is nearing depletion. The notification module 124 ensures that the user receive timely notifications about the remaining time in the time-based credit module 110. By proactively informing the user of the time credits status, the notification module 124 enhances the overall user experience and helps prevent interruptions in content consumption.

In one embodiment, the frame-based tracking system 100 provides unique approach to media content consumption through frame-based tracking and time credit deduction. Unlike conventional methods that rely on flat fees or subscription models, the frame-based tracking system 100 monitors the exact number of frames viewed in the selected video by the user, ensuring that the user is only charged for content consumed. The tracking module 118 tracks the number of frames viewed from the selected video, while the time estimation module 120 estimates and deducts viewing time from the purchased time credits based on the number of frames viewed. This frame-based method provides a more granular and accurate pricing model, making it highly efficient and user-friendly. By providing the user the flexibility to pay for content based on actual consumption, the frame-based tracking system 100 improves affordability and increases user satisfaction, particularly for those who may only need partial access to certain videos or courses. The frame-based tracking system 100 combinations frame-based tracking, time credit deduction, and flexible pricing that marks a significant advancement over existing content consumption models, solving key problems related to unfair billing and inefficient use of subscriptions.

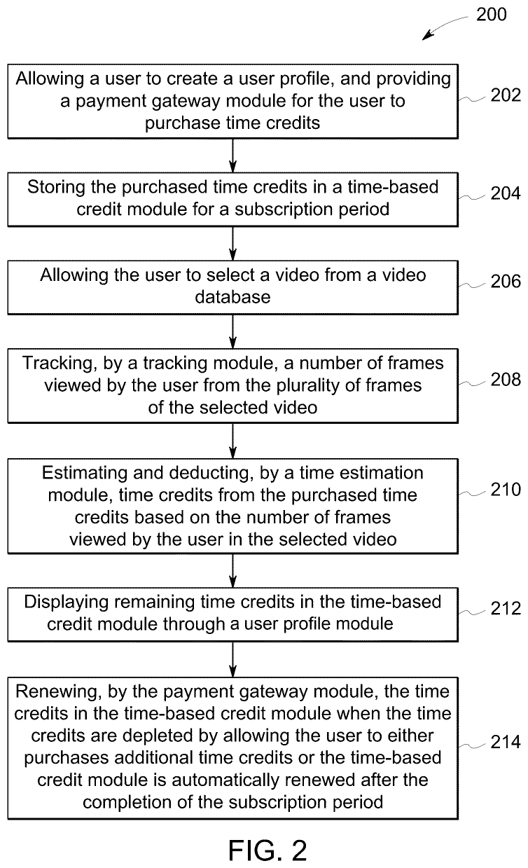

FIG. 2 refers to a flowchart 200 of a method for frame-based tracking and pricing for video consumption. At step 202, the user allowed to create the user profile through the user profile module 108 by providing user data. The user data includes, but not limited to, name, age, and preferred types of video, etc. After completion of the user data input, the frame-based tracking system 100 creates the user profile in the frame-based tracking system 100 with the time-based credit module 110, as depicted in step 204. The user interacts with the frame-based tracking system 100 using the computing device 102, during which various pricing options and media content, including a plurality of videos, are displayed to the user.

In one embodiment, the user selects and purchases the desired amount of time credits by choosing the pricing option from various pricing options, through the payment gateway module 122.

At step 206, after purchasing the desired amount of time credits, the user is allowed to select at least one video from the database 116. At step 208, the tracking module 118 tracks the number of frames viewed by the user from the plurality of frames of the selected video. At step 210, the time estimation module 120 estimates and deducts an amount of time from the purchased time credits based on the number of frames viewed by the user in the selected video. At step 212, the remaining amount of the purchased time credits is displayed in the time-based credit module 110 through the user profile.

If the purchased time credits are exhausted or depleted, the user is redirected to the payment gateway module 122, as depicted at step 214. Here, the user is enabled to either select and purchase additional time credits from the various pricing options or allow the time-based credit module 110 to automatically renew after the completion of the subscription period.

In one embodiment, the frame-based tracking system 100 monitors the number of frames viewed by the user in a video, and then accurately estimates and deducts the corresponding amount of time from a purchased time credits based on the frames viewed. This approach ensures fair billing, as users are charged solely for the content they consume, offering a more flexible and cost-effective pricing model compared to traditional flat-rate or subscription-based systems.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principles of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

It will readily be apparent that numerous modifications and alterations can be made to the processes described in the foregoing examples without departing from the principles underlying the invention, and all such modifications and alterations are intended to be embraced by this application.

The claimed invention is:

1. A frame-based tracking system for a video consumption, comprising:
a computing device having a processor and a memory for storing one or more instructions executable by the processor, wherein the computing device is in communication with a server via a network,
wherein the processor being operable when executing the one or more instructions to:
enable a user to create a user profile through a user profile module, and allow the user to access a payment gateway module to purchase time credits;
store the purchased time credits in a time-based credit module for a subscription period;
allow the user to select media content stored in a database, wherein the media content includes a plurality of videos, which are composed of a plurality of frames;
detect, by a tracking module, a frame rate of a selected media content during playback and track a number of frames consumed by the user,
wherein the number of frames consumed is determined by correlating the detected frame rate with a duration of playback of the selected media content;
estimate and deduct, by a time estimation module, the time credits from the time-based credit module based on the number of frames of the selected media content consumed by the user;
display, by a user interface, remaining time credits stored in the time-based credit module; and
enable the user to purchase the time credits through the payment gateway module when the time credits are consumed.

2. The frame-based tracking system of claim 1, wherein the time credits are measured in at least one of minutes and hours.

3. The frame-based tracking system of claim 1, wherein the subscription period comprises at least one of a free subscription period with 15 min of media content, a subscription period with 60 min of media content monthly for a course and a video, a subscription period with two hours of media content monthly for a course and a video, a subscription period with five hours of media content monthly for a course and a video, a subscription period with 10 hours of media content monthly for a course and a video, and an unlimited subscription period.

4. The frame-based tracking system of claim 1, wherein the payment gateway module is configured to allow the user to upgrade, downgrade, and cancel the subscription period.

5. The frame-based tracking system of claim 1, wherein the payment gateway module is configured to automatically renew the time credits at an end of each subscription period.

6. The frame-based tracking system of claim 1, wherein the payment gateway module is configured to provide various payment method for the user to purchase the time credits.

7. (canceled)

8. The frame-based tracking system of claim 1, wherein the frame-based tracking system further comprises a notification module that is configured to provide one or more notifications to the user indicating depletion of the time credits.

9. A method for tracking and pricing video consumption through a frame-based tracking system, comprising:
allowing, by a user profile module, a user to create a user profile, and providing a payment gateway module for the user to purchase time credits;
storing the purchased time credits in a time-based credit module for a subscription period;
allowing the user to select a video from a database, wherein the video comprises a plurality of frames;
detecting, by a tracking module, a frame rate of a selected media content during playback and tracking a number of frames consumed by the user,
wherein the number of frames consumed is determined by correlating the detected frame rate with a duration of playback of the selected media content;
estimating and deducting, by a time estimation module, time credits from the purchased time credits based on the number of frames viewed by the user in the selected video;
displaying remaining time credits in the time-based credit module through the user profile module; and
renewing, by the payment gateway module, the time credits in the time-based credit module when the time credits are depleted by allowing the user to either purchases additional time credits or the time-based credit module is automatically renewed after the completion of the subscription period.

10. The method of claim 9, wherein the time credits are measured in at least one of minutes and hours.

11. The method of claim 9, wherein the subscription period comprises at least one of a free subscription period with 15 min of media content, a subsc1iption period with 60 min of media content monthly for a course and a video, a subscription period with two hours of media content monthly for a course and a video, a subscription period with five hours of media content monthly for a course and a video, a subscription period with 10 hours of media content monthly for a course and a video, and an unlimited subscription period.

12. The method of claim 9, wherein the payment gateway module is configured to allow the user to upgrade, downgrade, and cancel the subscription period.

13. The method of claim 9, wherein the payment gateway module is configured to automatically renew the time credits at an end of each subscription period.

14. The method of claim 9, wherein the payment gateway module is configured to provide various payment method for the user to purchase the time credits.

15. (canceled)

16. The method of claim 9, wherein the frame-based tracking system further comprises a notification module that is configured to provide one or more notifications to the user indicating depletion of the time credits.
